(19) United States
(12) Patent Application Publication
(10) Pub. No.: US 2026/0197036 A1
(43) Pub. Date: Jul. 9, 2026

(54) BEAM MANAGEMENT AND TRACKING SYSTEM AND METHOD FOR RECONFIGURABLE INTELLIGENT SURFACE

(71) Applicant: National Yang Ming Chiao Tung University, Hsinchu City (TW)

(72) Inventors: Sau-Hsuan WU, New Taipei City (TW); Hsin-Li CHIU, Hsinchu City (TW); Chun-Hsien KO, Hsinchu City (TW)

(21) Appl. No.: 19/433,986

(22) Filed: Dec. 29, 2025

(30) Foreign Application Priority Data
Dec. 30, 2024 (TW) 113151565

(51) Int. Cl. H04B 7/04; H04B 7/06; H04W 24/10

(52) U.S. Cl. CPC H04B 7/04013; H04B 7/06952; H04W 24/10

(57) ABSTRACT

The present disclosure provides a method for beam management and tracking of a reconfigurable intelligent surface. The method includes: measuring or receiving measurement reports of user devices by a base station; calculating positions of the user devices and beams to be provided to the user devices based on the measurement reports and a quantity of the user devices; calculating a period length of a first beam configuration period and a period length of a second beam configuration period based on the quantity, the positions, and the measurement reports; generating a first grid of beams by the reflecting surface to track the user devices in the first beam configuration period; and providing beams to serve the user devices by a second grid of beams generated by the reflecting surface in the second beam configuration period.

### CROSS-REFERENCE TO RELATED APPLICATIONS

This application claims priority to Taiwan Application Serial Number 113151565, filed Dec. 30, 2024, which is herein incorporated by reference.

### BACKGROUND

### Technical Field

The present disclosure is a beam management system for reconfigurable intelligent surface and beam tracking and allocation method system for reconfigurable intelligent surface, configuring to track and serve multiple user devices simultaneously.

### Description of Related Art

The beam management technique of Reconfigurable Intelligent Surface (RIS) involves a trade-off relationship between beam allocation and beam tracking within a same communication system. When performing beam allocation or scheduling, losing beam-tracking connection may miscalculate the signal power from users, which reduces beam allocation performance. The beam scanning resources are required if the tracking of beam connection is to be persisted. Therefore, selecting appropriate Grid of Beams (GoB), beam-tracking period management, and beam connection are crucial to promote tracking accuracy and system overall efficiency for beam allocation.

### SUMMARY

The present disclosure provides a method for beam management and tracking of a reconfigurable intelligent surface, the method comprises receiving the measurement report transmitted by user devices or base stations, calculating positions of the user, a beam configuration direction of intelligent surface, and calculating a first beam configuration period and a second beam configuration period according to the measurement report and a quantity of the user devices, and scanning and tracking the user devices through a first grid of beams generated by the reflecting surface in the first beam configuration period, and serving the user devices through a second grid of beams generated by the reflecting surface in the second beam configuration period.

The present disclosure provides a system for beam management and tracking of a reconfigurable intelligent surface, the system comprises a controller, a base station, a first reflecting surface controlled by the controller or the base station, and user devices configured to receive a scanning signal transmitted by the first reflecting surface, wherein the controller is configured to receive the measurement reports from the user devices or the base station, and calculate a first beam configuration period and a second beam configuration period according to the measurement report. In the first beam configuration period, the controller scans and tracks the user devices through a first grid of beams generated by the reflecting surface. In the second beam configuration period, the controller allocates a second grid of beams generated by the reflecting surface to serve the user devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a communication system for joint RIS beam allocation and tracking, illustrated in accordance with some embodiments of the present disclosure.

FIG. 2 is a timing diagram of joint RIS beam tracking and management, illustrated in accordance with some embodiments of the present disclosure.

FIG. 3 is a timing diagram of beam-tracking configuration periods, illustrated in accordance with some embodiments of the present disclosure.

FIG. 4 is a timing diagram of beam-allocating configuration periods, illustrated in accordance with some embodiments of the present disclosure.

FIG. 5 is a flowchart diagram of a method for operating a communication system, illustrated in accordance with some embodiments of the present disclosure.

### DETAILED DESCRIPTION

In the present disclosure, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present invention belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising) ” and/or “includes (including)” designate the existence of stated features, steps, operations, elements and/or components, but the existence or addition of one or more other features, steps, operations, elements, components, and/or groups thereof are not excluded.

Hereinafter multiple embodiments of the present disclosure will be disclosed with accompanying drawings, as clearly stated, the details in many practices it will be explained in the following description. It should be appreciated, however, that the details in these practices is not applied to limit the present disclosure. Also, it is to say, in some embodiments of the present disclosure, the details in these practices are non-essential. In addition, for the sake of simplifying accompanying drawings, some known usual structures and element in the drawings by a manner of simply illustrating for it.

The technique of the Reconfigurable Intelligent Surfaces (RIS) has rapidly developed among communication and wireless internet fields in recent years. Beam management is an important application field if RIS technique, which is configured to attenuate or enhance wireless signals emitted at a specific angle by adjusting the phase shifter on the RIS. This feature allows the RIS beam management become the only critical technique that is able to proactively change the channel environments and promote the communication performance.

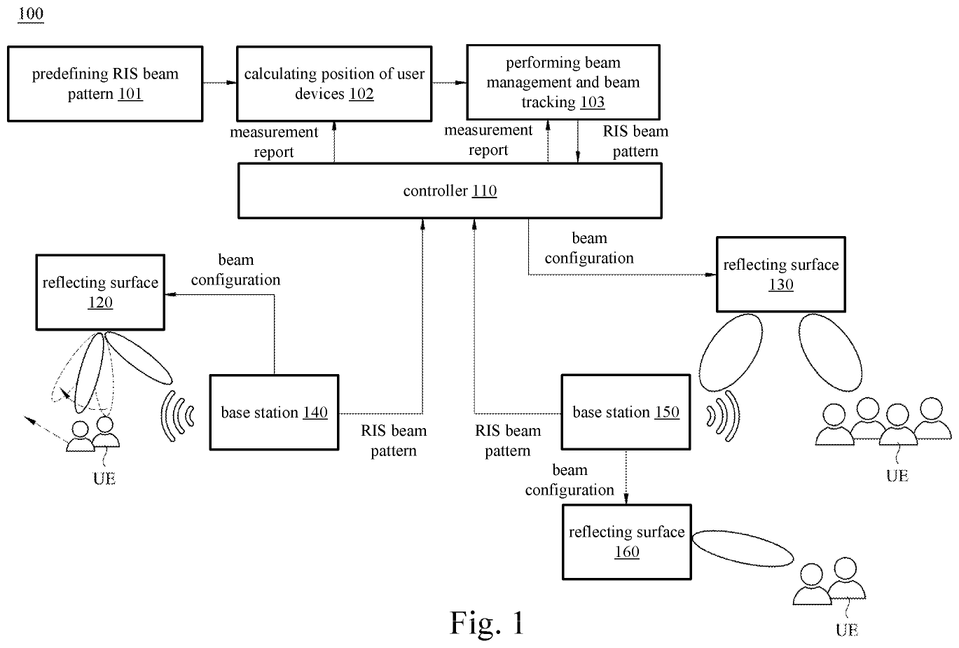

FIG. 1 is a schematic diagram of a communication system 100 for joint RIS beam allocation and tracking, illustrated in accordance with some embodiments of the present disclosure.

As illustratively shown in FIG. 1, the communication system 100 includes a controller 110, base stations 140 and 150, reflecting surfaces 120, 130, and 160, and multiple user devices UE. However, the present disclosure is not limited to this. In various embodiments, the communication system 100 can include various quantities of base stations and reflecting surfaces.

The controller 110 is configured to control the configuration of RIS beam pattern of the reflecting surface 130 and the tracking of the user devices UE. the base stations 140 and 150 are respectively configured to control the configuration of RIS beam pattern of the reflecting surfaces 120 and 160 and the tracking of the user devices UE.

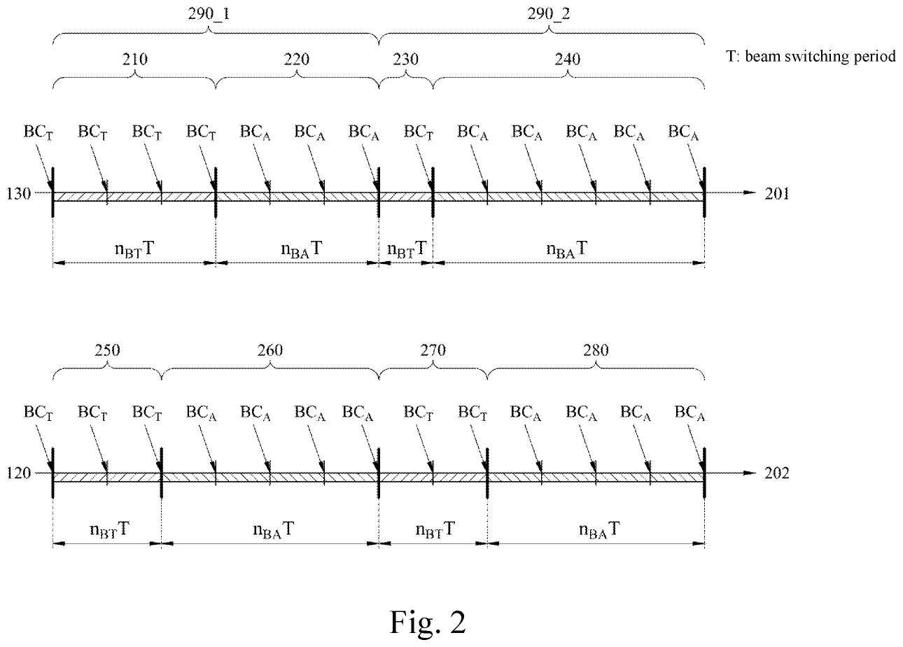

In some embodiments, the RIS beam pattern is a type of configuration of the Grid of Beams (GoB) that is used for scanning. The embodiments of the present disclosure include, but are not limited to, one type of the RIS beam pattern. In some embodiments, the RIS beam pattern that is used for scanning performs beam configuration with a fixed period, the RIS beam pattern that is used for communication service performs beam configuration during a beam-allocating configuration period, and further details is discussed in the corresponding paragraphs of FIG. 2.

In some embodiments, the reflecting surfaces 120 and 160 can be implemented by a base-station-assisted RIS. The reflecting surface 130 can be implemented by a network-controlled RIS. Specifically, the base station 140 is configured to control the reflecting surface 120. The base station 150 is configured to control the reflecting surface 160. The controller 110 controls the reflecting surface 130 through the internet. FIG. 1 further includes processes 101-103 for the operation of the communication system 100.

In general, the reflecting surfaces 120, 130 and 160 mentioned above include M*N reflecting elements, wherein N and M are integers. The reflecting surfaces 120, 130 and 160 can enhance the signal power on a specific direction and suppress the signal interference level on a designated direction by adjusting lateral displacement on the reflecting element that generates constructive interference or destructive interference on the specific direction. Normally, using the reflecting surfaces 120, 130 and 160 has the following purposes: improving signal dead zone, increasing channel capacity, improving positioning accuracy, increasing mobility performance, promoting energy efficiency. Achieving these purposes rely on correct beam association, and correspondingly consumes wireless channel resources and continuously performs beam-scanning. Wherein these resources and the beam-scanning are related to the quantity of the user devices UE. For example, when the quantity of the user devices UE is more, frequent beam-scanning is required to be performed and track the positions of the user devices UE to provide a correct beam connection. When the quantity of the user devices UE is less, then the resources used to beam-scanning and tracking can be reduced. In addition, the positions of the user devices UE are related to the change of the Reference Signal Received Power (RSRP) of the user devices UE. Relative to the beam-scanning performed by the reflecting surfaces 120, 130, and 160, the base station or the user devices UE perform measurement periodically and generate measurement reports (MR). The user devices UE transmit the measurement reports to the base stations 140 and 150, the base stations 140 and 150 transmit the measurement reports mentioned above to the controller 110 to perform adjustment of the beam management period and beam configuration of the RIS.

In some embodiments, as illustratively shown in the process 101 in the FIG. 1, the controller 110 provides the GoB for scanning to scan the user devices UE, and receives the measurement reports transmitted back from the user devices UE through the base stations 140 and 150.

In some embodiments, the controller 110 indirectly controls the reflecting surfaces 120 and 160 respectively through the base stations 140 and 150, and tracks the user devices UE. Specifically, the controller 110 respectively controls the reflecting surfaces 120 and 160 through the base stations 140 and 150, and the reflecting surfaces 120 and 160 perform beam-scanning to the user devices UE. The base stations 140 and 150 receive the measurement reports transmitted back from the user devices UE and statically collects multiple self-measurement data and parameters, the base stations 140 and 150 transmit the received measurement reports and the multiple self-measurement data and parameters to the controller 110. The controller 110 calculates the positions and the signal powers of the user devices UE.

In some embodiments, the controller 110 directly controls the reflecting surface 130 and tracks the user devices UE. Specifically, the controller 110 controls the reflecting surface 130, and performs the beam-scanning to the user devices UE by the reflecting surface 130. The base stations 140 and 150 receive the measurement reports transmitted back from the user devices UE periodically, and statically collects its own multiple measurement data and parameters, then the base stations 140 and 150 transmit the received measurement reports and its own measurement data and parameters to the controller 110. The controller 110 calculates the positions and signal powers of the user devices UE.

In some embodiments, the multiple measurement data and parameters of the base stations 140 and 150 include: signal powers between users and multiple base stations, loadings of the base stations, uplink and downlink throughput of the base stations, handover performance of the base stations, radio link failure (RLF), or beam failure.

In the process 102, the controller 110 further calculates the moving direction of the user devices UE through the changes in location of the user devices UE. In addition, the location changes and the moving direction of the user devices UE are related to the RSRP.

In the process 103, the controller 110 correspondingly calculates the RIS beam management period after the position and the RSRP of the user devices UE are calculated, and re-configurates the RIS beam pattern mentioned previously. Specifically, in some embodiments, the controller 110 adjusts the direction of the RIS reflected beam according to the position and the RSRP of the user devices UE, and configurates the RIS beam pattern for scanning. For example, in the range of 0 degree to 30 degrees has more user devices UE, thus the controller 110 adjusts the directional angle of the RIS beam pattern for scanning to 0 degree to 30 degrees, so as to encompass more user devices UE, the present disclosure includes, but is not limited to, the embodiment described herein. For another example, the controller 110 adjusts the reflecting angle of the RIS reflected beam by 30 degrees to the right, so as to generate a constructive interference to enhance the signal powers to the user devices UE, the present disclosure includes, but is not limited to, the embodiment described herein.

In the embodiment shown in FIG. 1, the controller 110 transmits the beam configuration to the base station 140, and the base station 140 controls the reflecting surface 120 to perform the beam-scanning to the multiple user devices UE. Similarly, the controller 110 transmits the beam configuration to the base station 150, and the base station 150 controls the reflecting surface 160 to perform a beam-allocation to multiple user devices UE. At the same time, the controller 110 transmits the beam configuration to the reflecting surface 130, and the reflecting surface 130 performs the beam-allocation to multiple user devices UE, but the present disclosure is not limited to the embodiment described herein.

In some embodiments, the reflecting surfaces 120, 130, and 160 can perform the beam-scanning and/or the beam-allocation to multiple user devices UE, the base station 140 can control the reflecting surface 120 and/or the reflecting surface 160, the base station 150 can control the reflecting surface 120 and/or the reflecting surface 160, wherein the communication system 100 can include one or multiple base stations 140 and 150, and the communication system 100 can include one or multiple reflecting surfaces 120, 130, and 160.

FIG. 2 is a timing diagram of joint RIS beam tracking and management, illustrated in accordance with some embodiments of the present disclosure.

As illustratively shown in FIG. 2, FIG. 2 includes timelines 201 and 202. the timelines 201 and 202 correspond to operations of the reflecting surfaces 130 and 120, respectively.

In the embodiment shown in FIG. 2, the timeline 201 includes beam-tracking configuration periods 210, 230 and beam-allocating configuration periods 220, 240. The beam-tracking configuration period 210, the beam-allocating configuration period 220, the beam-tracking configuration period 230, and the beam-allocating configuration period 240 are arranged continuously and in order.

In some embodiments, as illustratively shown in FIG. 2, a RIS beam management period 290_1 includes the beam-tracking configuration period 210 and the beam-allocating configuration period 220. A RIS beam management period 290_2 includes the beam-tracking configuration period 230 and the beam-allocating configuration period 240.

As illustratively shown in the embodiment of FIG. 2, in the beam-tracking configuration periods 210 and 230, the controller 110 generates multiple beam-tracking configuration BC_{T}, and the reflecting surface 130 is configured to scan and track the position of the user devices UE. In the beam-allocating configuration periods 220 and 240, the controller 110 generates multiple beam-allocating configuration BC_{A}, and the reflecting surface 130 is configured to allocate the calculated beam to serve the user devices UE according to the controller 110 evaluating the measurement reports provided by the beam-tracking configuration periods 210 and 230. Specifically, in the beam-tracking configuration periods 210 and 230, the controller 110 scans the user devices UE by the beam-tracking configuration BC_{T}, and the base station 140 measures or receives the signal or the measurement reports transmitted by the user devices UE. The base station 140 transmits the measurement reports to the controller 110, and calculates the positions and the signal powers of the user devices UE according to parameters of the beam-tracking configuration BC_{T}. In the beam-allocating configuration periods 220 and 240, the controller 110 evaluates multiple optimized parameters and the GoB according to the calculated result, and transmits the optimized parameters and GoB to the reflecting surface 130 through the beam-allocating configuration BC_{A}.

In some embodiments, the evaluated multiple optimized parameters and GoB mentioned above are generated by the controller 110 performing a computation to the positions and the signal powers of the user devices UE through an algorithm.

As illustratively shown in the embodiment of FIG. 2, a period length of the beam-tracking configuration periods 210 and 230 can be represented by n_{BT}T with an integer n_{BT} and a period T. Each interval in the beam-tracking configuration periods 210 and 230 represents one period T. Alternatively stated, each of the beam-tracking configuration periods 210 and 230 has n_{BT} period T. In each of the beam-tracking configuration periods 210 and 230, the reflecting surface 130 performs n_{BT} counts of the beam-tracking configuration BC_{T}.

On the other hand, a period length of the beam-allocating configuration periods 220 and 240 can be represented by n_{BA}T with an integer n_{BA} and the period T. Each interval in the beam-allocating configuration periods 220 and 240 represent one period T. Alternatively stated, each of the beam-allocating configuration periods 220 and 240 has n_{BA} period T. In each of the beam-allocating configuration periods 220 and 240, the reflecting surface 130 performs n_{BA} counts of the beam-allocating configuration BC_{A}.

In some embodiments, as illustratively shown in FIG. 2, the period length n_{BT}T of the beam-tracking configuration periods 210 and 230 and the period length n_{BA}T of the beam-allocating configuration periods 220 and 240, corresponding to a period length nT of the RIS beam management periods 290_1 and 290_2 have the following relationship: n=n_{BT}+n_{BA}, wherein n is an integer. In some embodiments, each RIS beam management periods has the same period length nT. For example, the period lengths nT of the RIS beam management periods 290_1 and 290_2 are the same.

For example, as illustratively shown in FIG. 2, the RIS beam management period 290_1 includes six intervals of the period T and has the integer n=6. In this example, the beam-tracking configuration period 210 corresponding to the RIS beam management period 290_1 includes three intervals of the period T and has the integer n_{BT}=3, the beam-allocating configuration period 220 corresponding to the RIS beam management period 290_1 includes three intervals of the period T and has the integer n_{BA}=3.

For another example, as illustratively shown in FIG. 2, the RIS beam management period 290_2 includes six intervals of the period T and has the integer n=6. In this example, the beam-tracking configuration period 230 corresponding to the RIS beam management period 290_2 includes an interval of the period T and has the integer n_{BT}=1, the beam-allocating configuration period 240 corresponding to the RIS beam management period 290_2 includes five intervals of the period T and has the integer n_{BA}=5.

In some embodiments, the controller 110 determines the integers n_{BT} and n_{BA} according to the quantity of the users, the signal powers, and the service quality. The period lengths n_{BT}T and n_{BA}T included in the period length nT of the RIS beam management periods 290_1 and 290_2 can be distributed according to the ratio of the n_{BT} and the n_{BA}.

In some embodiments, the starting time of the RIS beam management period 290_1 is the same as the starting time of the beam-tracking configuration period 210, and the ending time of the RIS beam management period 290_1 is the same as the ending time of the beam-allocating configuration period 220. The starting time of the RIS beam management period 290_2 is the same as the starting time of the beam-tracking configuration period 230, and the ending time of the RIS beam management period 290_2 is the same as the ending time of the beam-allocating configuration period 240.

In the embodiment shown in FIG. 2, the timeline 202 includes the beam-tracking configuration periods 250, 270 and the beam-allocating configuration periods 260, 280. The beam-tracking configuration period 250, the beam-allocating configuration period 260, the beam-tracking configuration period 270, and the beam-allocating configuration period 280 are arranged continuously and in order.

In some embodiments, as illustratively shown in FIG. 2, the RIS beam management period 290_1 includes the beam-tracking configuration period 250 and the beam-allocating configuration period 260. The RIS beam management period 290_2 includes the beam-tracking configuration period 270 and the beam-allocating configuration period 280.

As illustratively shown in the embodiment of FIG. 2, in the beam-tracking configuration periods 250 and 270, the controller 110 generates multiple beam-tracking configurations BC_{T}, and the reflecting surface 130 is configured to scan and track the position of the user devices UE. In the beam-allocating configuration periods 260 and 280, the controller 110 generates multiple beam-allocating configurations BC_{A}, and the reflecting surface 130 is configured to allocate the calculated beam to serve the user devices UE according to the controller 110 evaluating the measurement reports provided by the beam-tracking configuration periods 250 and 270. Specifically, in the beam-tracking configuration periods 250 and 270, the controller 110 scans the user devices UE through the beam-tracking configuration BC_{T}, and the base station 140 measures or receives the signal or the measurement reports transmitted by the user devices UE. The base station 140 transmits the measurement reports to the controller 110, and calculates the positions and the signal powers of the user devices UE according to the beam-tracking configuration BC_{T}. In the beam-allocating configuration periods 260 and 280, the controller 110 evaluates multiple optimized parameters and the GoB according to the calculated result, and transmits the optimized parameters and GoB to the reflecting surface 130 through the beam-allocating configuration BC_{A}.

As illustratively shown in the embodiment of FIG. 2, a period length of the beam-tracking configuration periods 250 and 270 can be represented by n_{BT}T with an integer n_{BT} and the period T. Each interval of the beam-tracking configuration periods 250 and 270 represents one period T. Alternatively stated, each of the beam-tracking configuration periods 250 and 270 has n_{BT} the period T. In each of the beam-tracking configuration periods 250 and 270, the reflecting surface 130 performs n_{BT} counts of the beam-tracking configuration BC_{T}.

On the other hand, a period length of the beam-allocating configuration periods 260 and 280 can be represented by n_{BA}T with an integer n_{BA} and the period T. Each interval of the beam-allocating configuration periods 260 and 280 represents one period T. Alternatively stated, each of the beam-allocating configuration periods 260 and 280 has n_{BA} period T. In each of the beam-allocating configuration periods 260 and 280, the reflecting surface 130 performs n_{BA} counts of the beam-allocating configuration BC_{A}.

In some embodiments, as illustratively shown in FIG. 2, the period length n_{BT}T of the beam-tracking configuration periods 250 and 270 and the period length n_{BA}T of the beam-allocating configuration periods 260 and 280, corresponding to the period length nT of the RIS beam management periods 290_1 and 290_2 have the following relationship: n=n_{BT}+n_{BA}, wherein n is an integer. In some embodiments, each of the RIS beam management periods has the same period length nT. For example, the period lengths nT of the RIS beam management periods 290_1 and 290_2 are the same.

For example, as illustratively shown in FIG. 2, the RIS beam management period 290_1 includes six intervals of the period T and has the integer n=6. In this example, the beam-tracking configuration period 250 corresponding to the RIS beam management period 290_1 includes two intervals of the period T and has the integer n_{BT}=2, the beam-allocating configuration period 260 corresponding to the RIS beam management period 290_1 includes four intervals of the period T and has the integer n_{BA}=4.

For another example, as illustratively shown in FIG. 2, the RIS beam management period 290_2 includes six intervals of the period T and has the integer n=6. In this example, the beam-tracking configuration period 270 corresponding to the RIS beam management period 290_2 has two intervals of the period T and has the integer n_{BT}=2, the beam-allocating configuration period 280 corresponding to the RIS beam management period 290_2 has four intervals of the period T and has the integer n_{BA}=4.

In some embodiments, the starting time of the RIS beam management period 290_1 is the same as the starting time of the beam-tracking configuration period 250, and the ending time of the RIS beam management period 290_1 is the same as the ending time of the beam-allocating configuration period 260. The starting time of the RIS beam management period 290_2 is the same as the starting time of the beam-tracking configuration period 270, and the ending time of the RIS beam management period 290_2 is the same as the ending time of the beam-allocating configuration period 280.

In some embodiments, the base station 140 in FIG. 2 can be implemented by the base station 150 in FIG. 1. The reflecting surface 120 in FIG. 2 can be implemented by the reflecting surface 160 in FIG. 1.

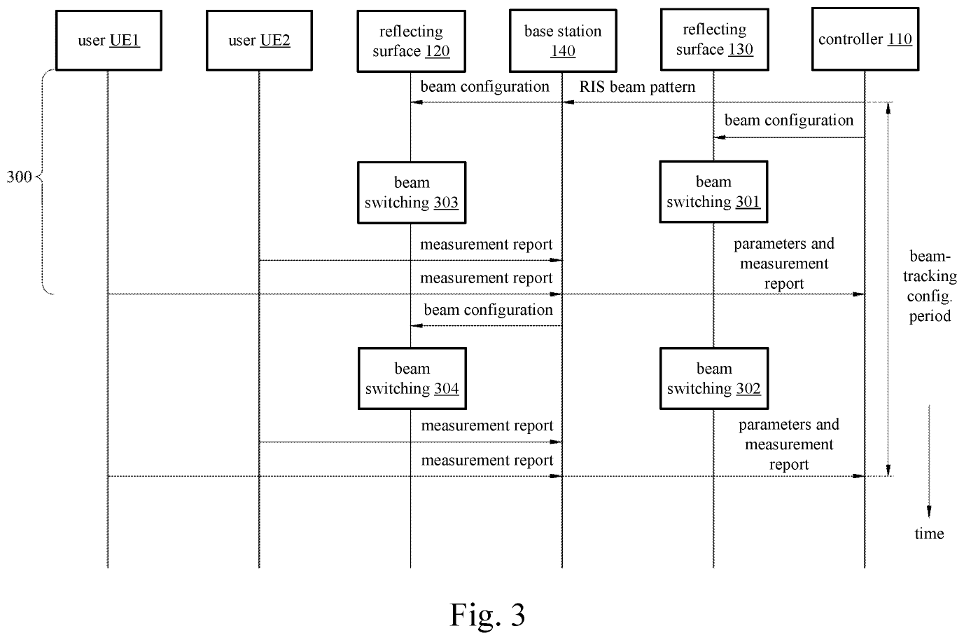

FIG. 3 is a timing diagram of the beam-tracking configuration periods 210 and 230, illustrated in accordance with some embodiments of the present disclosure.

As illustratively shown in FIG. 3, FIG. 3 includes the controller 110, the reflecting surface 120, the reflecting surface 130, the base station 140, and the user devices UE in FIG. 1, wherein the user devices UE are implemented by the user devices UE1 and UE2 in FIG. 3. FIG. 3 further includes a period operation 300, beam switchings 301 and 302 corresponding to the reflecting surface 130, and beam switchings 303 and 304 corresponding to the reflecting surface 120.

As illustratively shown in FIG. 3, in the period operation 300, at a first beam-tracking period (the integer n_{BT}=1), the controller 110 is configured to transmit the RIS beam pattern to the reflecting surface 130, wherein the RIS beam pattern is the beam-tracking configuration BC_{T}. The reflecting surface 130 performs the beam switching 301 according to the received beam-tracking configuration BC_{T}, and performs the beam-scanning to the user devices UE1 and UE2.

As illustratively shown in FIG. 3, in the period operation 300, the controller 110 is configured to transmit the RIS beam pattern for scanning to the base station 140. The base station 140 transmits the RIS beam pattern to the reflecting surface 120, wherein the RIS beam pattern is the beam-tracking configuration BC_{T}. The reflecting surface 120 performs the beam switching 303 according to the received beam-tracking configuration BC_{T}, and performs the beam-scanning to the user devices UE.

In some embodiments, the base station 140 is configured to measure or receive the measurement reports or the signal transmitted by the user devices UE. The base station 140 statistically collects its own data and the measurement reports and transmits to the controller 110, the controller 110 calculates the positions and the signal powers of the user devices UE1 and UE2. At this moment the period operation 300, that is the first period length n_{BT}T, is completed.

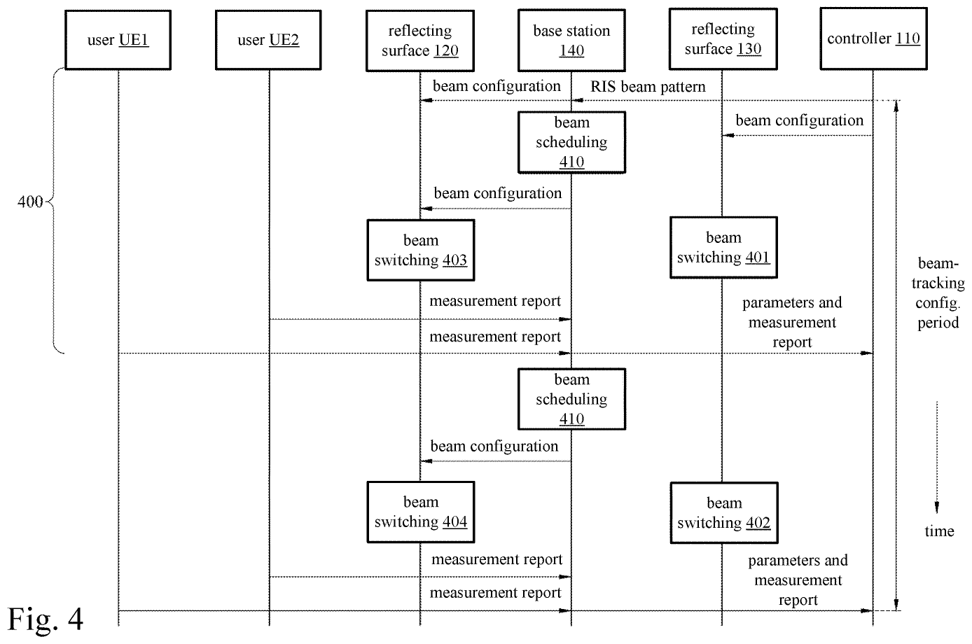

The controller 110 correspondingly calculates the RIS beam management period according to the positions and the signal powers of the user devices UE1 and UE2. Specifically, when the reflecting surfaces 120 and 130 perform the beam-scanning, the controller 110 can calculate the positions and the signal powers of the user devices UE, and predict proportions of the users within a beam-scanning range according to the beam-scanning range and the calculated positions and the signal powers of the user devices UE. If the proportions of the users calculated by the controller 110 are concentrated in multiple specific directions, then switch to the beam-allocating configuration period, that is the beam-allocating configuration period 220 in FIG. 2 and FIG. 4, and the reflecting surfaces 120 and 130 perform scanning focusing on the specific directions. On the contrary, if the controller 110 calculates that the proportions of the user are widely distributed, or are not concentrated in a specific direction, then repeat the period operation 300 according to the beam-tracking shown in FIG. 3, that is the second period (the integer n_{BT}=2) operation, and so forth.

In some embodiments, the base station 140 in FIG. 3 can be implemented by the base station 150 in FIG. 1. The reflecting surface 120 in FIG. 3 can be implemented by the reflecting surface 160 in FIG. 1.

FIG. 4 is a timing diagram of the beam-allocating configuration periods 220 and 240, illustrated in accordance with some embodiments of the present disclosure.

As illustratively shown in FIG. 4, FIG. 4 includes the controller 110, the reflecting surface 120, the reflecting surface 130, the base station 140, and the user devices UE in FIG. 1, wherein the user devices UE are implemented by the user devices UE1 and UE2 in FIG. 4. FIG. 4 further includes a period operation 400, beam switchings 305 and 306 corresponding to the reflecting surface 130, and beam switchings 307 and 308 corresponding to the reflecting surface 120. FIG. 4 further includes multiple beam-schedulings 410.

As illustratively shown in FIG. 4, in the period operation 400, at a first beam calculating period (the integer n_{BA}=1), the controller 110 is configured to calculate the positions and the signal powers of the user devices UE1 and UE2 according to the measurement reports transmitted back from the base station 140, and further calculate the RIS beam pattern for scanning and calculate multiple optimized parameters and the RIS GoB. The controller 110 transmits the RIS beam pattern for scanning, multiple optimized parameters, and the RIS GoB to the base station 140, the base station 140 performs the beam-schedulings 410 to the RIS beam pattern. The beam schedulings 410 include beam allocation order and count. The base station 140 controls the reflecting surface to scan multiple user devices UE and/or reflecting direction in order according to the beam allocation order and count.

In some embodiments, the beam-schedulings 410 are configured to configurate the RIS GoB according to the quantity and the position of the user devices UE. Specifically, the base station 140 performs the beam-scheduling and configurates a scheduling sequence of the RIS beam that serves the user devices UE based on the RIS GoB designed by the controller 110. The beam-schedulings 410 is configured to manage allocated directions of multiple RIS GoB, and the RIS GoB are further configured to serve the user devices UE according to multiple allocated directions.

For example, a first beam in the RIS GoB is configured to serve a first group of users in multiple user devices UE located at a first direction. A second beam in the RIS GoB is configured to serve a second group of users in multiple user devices UE located at a second direction. A third beam in the RIS GoB is configured to serve a third group of users in multiple user devices UE located at a third direction.

Continuing from the previous example, when the RIS GoB has three beams, and the RIS GoB performs the beam configuration to the user devices UE located in five directions, the first beam, the second beam, and the third beam in the RIS GoB serve the user devices UE in the first direction, the second direction, and the third direction, respectively. Then, when the servings of the RIS GoB to the user devices located in the first direction, the second direction, and the third direction are completed, the second beam and the third beam in the RIS GoB further serve the user devices UE located in the fourth direction and the fifth direction, respectively.

In some embodiments, the directions of the configurated beams can be expressed in degrees, such as the first direction indicating 0 degree to 30 degrees, the second direction indicating 30 degrees to 60 degrees, and the third direction indicating 60 degrees to 90 degrees, and so forth. However, the present disclosure is not limited to this interpretation and the degree range described herein.

In some circumstances, the base station 140 arranges the RIS beam pattern for scanning to scan six counts from the reflecting angle of 0 degree to 180 degrees with an increase of 30 degrees for each scanning in the beam-schedulings 410. Specifically, the base station 140 arranges the RIS beam pattern for scanning to perform a first scanning in a reflecting angle range of 0 degree to 30 degrees, a second scanning in a reflecting angle range of 30 degrees to 60 degrees, a third scanning in a reflecting angle range of 60 degrees to 90 degrees, a fourth scanning in a reflecting angle range of 90 degrees to 120 degrees, a fifth scanning in a reflecting angle range of 120 degrees to 150 degrees, and a sixth scanning in a reflecting angle range of 150 degrees to 180 degrees.

In some other circumstances, the base station 140 arranges the RIS beam pattern for scanning to scan, in order, a part of the user devices UE located at the positive 30 degrees, and then scan another part of the user devices UE located at the positive 240 degrees, but the present disclosure is not limited to the example described herein.

As illustratively shown in FIG. 4, in the period operation 400, the controller 110 is further configured to transmit multiple optimized parameters and the RIS GoB, to calculate the beam-tracking configuration BC_{A}, to the reflecting surface 130. The reflecting surface 130 performs a beam switching 401 according to the received beam-tracking configuration BC_{A}, and performs the beam-scanning and link to the user devices UE.

As illustratively shown in FIG. 4, in the period operation 400, the base station 140 transmits multiple optimized parameters and the RIS GoB, to calculate the beam-tracking configuration BC_{A}, to the reflecting surface 120. The reflecting surface 120 performs the beam switching 403 according to the received the beam-tracking configuration BC_{A}, and performs the beam-scanning and link to the user devices UE.

In some embodiments, the base station 140 continuously measures or receives the signals and the measurement reports transmitted from the user devices UE in the beam-allocating configuration period 220. The base station 140 statistically collects its own parameters and the measurement reports and transmits back to the controller 110, and the controller 110 continuously calculates the positions and the signal powers of the user devices UE. At this moment the period operation 400, that is the first period length n_{BA}T, is completed. The parameters mentioned above include: signal powers between users and multiple base stations, loadings of the base stations, uplink and downlink throughput of the base stations, handover performance of the base stations, radio link failure, or beam failure.

In some embodiments, the beam-schedulings 410 are performed once by the base station 140 in each period length n_{BA}T. The period operation 400 is repeated according to the beam allocating order and count included in the beam-schedulings 410. For example, the base station 140 performs the beam-schedulings 410 to the RIS beam pattern for scanning, the base station 140 performs three directions of scanning (such as positive 30 degrees, positive 60 degrees, positive 90 degrees) in the beam-schedulings 410, the period operation 400 is required to repeat three counts correspondingly to complete the scanning of the beam-schedulings 410. In response to the base station 140 performing three directions of scanning in the beam-schedulings 410, the beam-allocating configuration period 220 has gone through three n_{BA} periods T, but the present disclosure is not limited to the example described herein.

In some embodiments, based on the beam-schedulings 410 in the period operation 400, the communication system 100 switches from the beam-allocating configuration period 220 to the beam-tracking configuration period 210 after the period operation 400 is completed, and repeats the period operation 300 in FIG. 3.

In some embodiments, the base station 140 in FIG. 4 can be implemented by the base station 150 in FIG. 1. The reflecting surface 120 in FIG. 4 can be implemented by the reflecting surface 160 in FIG. 1.

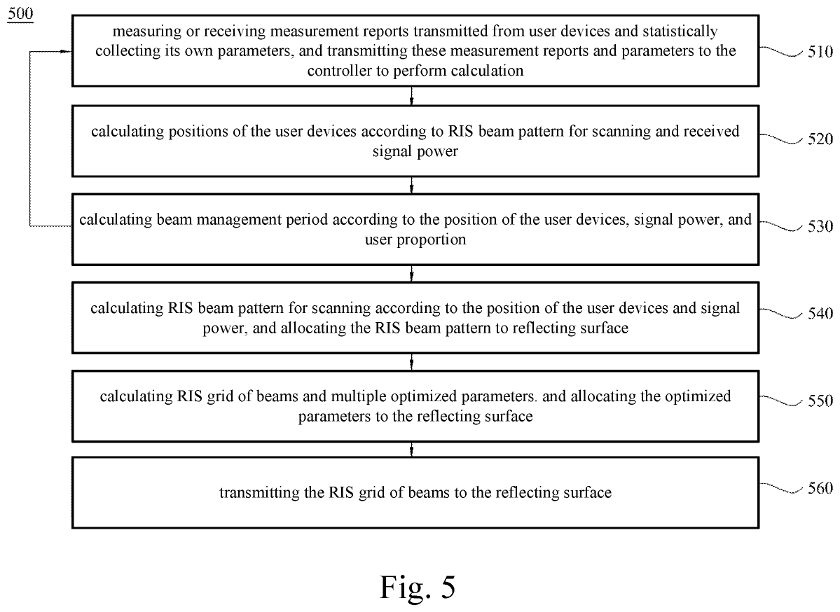

FIG. 5 is a flowchart diagram of a method 500 for operating the communication system 100, illustrated in accordance with some embodiments of the present disclosure.

As illustratively shown in FIG. 5, the method 500 includes processes 510 to 570. In the process 510, the base station 140 measures or receives the signals and the measurement reports transmitted from the user devices UE and statistically collects its own parameters. The base station 140 transmits these measurement reports and parameters to the controller 110 to perform the calculation.

In some embodiments, the parameters mentioned above include: signal powers between users and multiple base stations, loadings of the base stations, uplink and downlink throughput of the base stations, handover performance of the base stations, radio link failure, or beam failure. The process 510 proceeds to the process 520.

In some embodiments, referring to FIG. 2, the controller 110 transmits the beam-tracking configurations BC_{T}(0)-BC_{T}(n) for scanning to the reflecting surface 130 for every period T, the reflecting surface 130 generates the GoB to perform scanning and configuration to the user devices UE according to the beam-tracking configurations BC_{T}(0)-BC_{T}(n).

In some embodiments, the period T can be a beam switching period. For example, for every period T, the controller is switched to different RIS beam pattern and configured on the RIS, wherein the different RIS beam pattern mentioned above can be implemented with the purpose of changing the GoB reflecting direction and/or promoting the signal powers and attenuate noise signals correspondingly by constructive interference or destructive interference. In some embodiments, the beam-tracking configuration BC_{T} is the beam-tracking configuration BC_{T}(0) in the period T=0, the beam-tracking configuration BC_{T} is the beam-tracking configuration BC_{T}(1) in the period T=1, the beam-tracking configuration BC_{T} is the beam-tracking configuration BC_{T} (n) in the period T=n, and so forth.

In the process 520, the controller 110 calculates the position of the user devices UE according to the RIS beam pattern for scanning and the RSRP. The process 520 proceeds to the process 530.

In some embodiments, the positions of the user devices UE are related to the signal powers, which can be referred to the discussion of the beam-tracking configuration periods 210 and 230 in FIG. 3 and the beam-allocating configuration periods 220 and 240 in FIG. 4.

In the process 530, the controller 110 calculates the RIS beam management period according to the quantity, the positions, and the signal powers of the user devices UE. The operation of the communication system 100 proceeds to the process 540 from the process 530.

In some embodiments, the period lengths n_{BT}T and n_{BA}T can be determined according to the quantity, the position, the received signal powers and the service quality of the user devices UE. Further details regarding the period lengths n_{BT}T and n_{BA}T were discussed in FIG. 3 and FIG. 4 of the presented disclosure.

In some embodiments, the processes 510 to 530 in the method 500 are repeated processes. When the operation of the communication system 100 is proceed to the process 540 from the process 530, the communication system 100 repeats the processes 510 to 530.

In the process 540, the controller 110 calculates the RIS beam pattern for scanning according to the quantity, the positions and the signal powers of the user devices UE, and allocates the RIS beam pattern to the reflecting surface 120 and the reflecting surface 130. The process 540 proceeds to the process 550.

In the process 550, the controller 110 calculates the RIS GoB and multiple optimized parameters, and allocates the optimized parameters to the reflecting surface 120 and the reflecting surface 130. The process 550 proceeds to the process 560.

In some embodiments, the optimized parameters mentioned above can be systematic channel capacity, optimized performance index, or other similar parameters, the present disclosure includes, but is not limited to, these parameters.

In some embodiments, the processes 540 and 550 determine the period lengths of the beam-allocating configuration periods 220 and 240 according to the beam allocation order and the scanning count of the beam-schedulings 410 in FIG. 4. Specifically, when the count in the beam-schedulings 410 increases, the period length n_{BA}T increases, and the period lengths of the beam-allocating configuration periods 220 and 240 correspondingly increase. When the count of the beam-schedulings 410 decreases, the period length n_{BA}T decreases, and the period lengths of the beam-allocating configuration periods 220 and 240 correspondingly decrease.

In the process 560, the controller 110 transmits the RIS GoB to the reflecting surface 120 and the reflecting surface 130.

In some embodiments, the base station 140 in FIG. 5 can be implemented by the base station 150 in FIG. 1. The reflecting surface 120 in FIG. 5 can be implemented by the reflecting surface 160 in FIG. 1.

Although the present invention has been disclosed as above, it is not intended to limit the present invention. Those with ordinary knowledge in the technical field to which the present invention belongs can make various modifications and retouching without departing from the spirit and scope of the present invention.

What is claimed is:

1. A method for beam management and tracking of a reconfigurable intelligent surface, comprising:
measuring or receiving a plurality of measurement reports about a plurality of user devices by a base station;
calculating a plurality of positions of the plurality of user devices and a plurality of beams provided to the plurality of user devices according to the plurality of measurement reports and a quantity of the plurality of user devices;
calculating a period length of a first beam configuration period and a period length of a second beam configuration period according to the quantity, the plurality of positions and the plurality of measurement reports;
in the first beam configuration period, generating a first grid of beams to track the plurality of user devices by a reflecting surface; and
in the second beam configuration period, generating a second grid of beams to provide the plurality of beams to serve the plurality of user devices by the reflecting surface.

2. The method of claim 1, wherein
the period length of the first beam configuration period and the period length of the second beam configuration period are generated through an algorithm by performing a computation according to the quantity and the plurality of positions.

3. The method of claim 1, wherein
the first beam configuration period and the second beam configuration period correspond to a scheduling, the scheduling further comprises a scanning count,
wherein when the scanning count increases, the period length of the first beam configuration period increases; and
when the scanning count decreases, the period length of the first beam configuration period decreases.

4. The method of claim 3, wherein
the scheduling includes a plurality of allocated directions, and the second grid of beams provides the plurality of beams to serve the plurality of user devices according to the plurality of allocated directions.

5. The method of claim 1, wherein
the first beam configuration period and the second beam configuration period are arranged repeatedly and in order.

6. A system for beam management and tracking of a reconfigurable intelligent surface, comprising:
a controller;
a base station;
a first reflecting surface, controlled by the controller or the base station; and
a plurality of user devices configured to receive a scanning signal transmitted by the first reflecting surface,
wherein the controller is configured to receive a plurality of measurement reports from a plurality of base stations and the plurality of user devices, and determine a period length of a first beam configuration period and a period length of a second beam configuration period according to the plurality of measurement reports and a quantity of the plurality of user devices,
in the first beam configuration period, the controller generates a first grid of beams by a reflecting surface to scan and track the plurality of user devices; and
in the second beam configuration period, the controller allocates a second grid of beams generated by the reflecting surface to serve the plurality of user devices.

7. The system of claim 6, wherein the controller further includes an algorithm, the algorithm is configured to calculate a plurality of positions of the plurality of user devices according to the plurality of measurement reports and the quantity, and provide a plurality of beams for serving the plurality of user devices.

8. The system of claim 6, wherein
the first beam configuration period and the second beam configuration period correspond to a scheduling, the scheduling further includes a scanning count,
wherein when the scanning count increases, the period length of the first beam configuration period increases; and
when the scanning count decreases, the period length of the first beam configuration period decreases.

9. The system of claim 8, wherein
the scheduling includes a plurality of allocated directions, and the second grid of beams provides a plurality of beams to serve the plurality of user devices according to the plurality of allocated directions, and
wherein the first beam configuration period and the second beam configuration period are arranged repeatedly and in order.

10. The system of claim 7, wherein
the period length of the first beam configuration period and the period length of the second beam configuration period are generated through an algorithm by performing a computation according to the quantity, the plurality of positions, and a plurality of signal powers.
